(19) United States
(12) Patent Application Publication
(10) Pub. No.: US 2005/0155691 A1
(43) Pub. Date: Jul. 21, 2005

(54) Precure consolidator

(76) Inventors: David H. Nowak, High Point, NC (US); Stanley Schroeder, Ludington, MI (US)

Correspondence Address: IPLM GROUP, P.A., POST OFFICE BOX 18455, MINNEAPOLIS, MN, 55418, US

(21) Appl. No.: 11/010,896

(22) Filed: Dec. 13, 2004

Related U.S. Application Data
(62) Division of application No. 10/378,526, filed on Mar. 3, 2003, now abandoned.
(60) Provisional application No. 60/361,550, filed on Mar. 4, 2002.

(51) Int. Cl. B27N 3/00

(52) U.S. Cl. 156/62.2; 264/109

(57) ABSTRACT

The present invention provides a method for making a medium density fiberboard having a surface layer that is substantially similar to the subsurface layer. In one embodiment the method includes the step of applying a sealer composition having at least one of a release agent, bonding agent, or plasticizer to a fibermat and consolidating the fibermat.

### RELATED APPLICATION

This application claims the benefit of a pending U.S. provisional application Ser. No. 60/361,550, filed Mar. 4, 2002, entitled Precure Consolidator, which is herein incorporated by reference.

### TECHNICAL FIELD

This invention relates to the manufacture of fiberboards. In one embodiment, the present invention relates to the consolidation process and curing of medium density fiberboards.

### BACKGROUND

Medium Density Fiberboard (MDF) is manufactured by a variety of processes, one of which includes compressing a combination of cellulose wood fiber and binders (raw materials) in a hot press. In some processes, a stack press of several platens is used, while other processes employ a continuous press (e.g., using a steel belt).

Standard compression cycles typically employ pressing a fibermat (e.g., with a closed press) with the required heat to cause the desired consolidation of the raw materials to form a fiberboard. Unfortunately, the standard compression cycles typically result in a fiberboard having a deficient surface layer of compressed fibers on one or both surfaces that is difficult to coat, laminate or glue to. While not willing to be bound by theory, it is believed that the deficient surface layer on one or both surfaces is comprised of fibers that are prematurely cured. The deficient surface layer of the MDF made by conventional processes generally also has less cohesive strength and a lower density than an underlying portion of the fiberboard.

Conventionally, one or both of the deficient surface layers (sometimes called “precured layers”) of the medium density fiberboards are removed by sanding. The conventional MDF manufacturing process is therefore wasteful, time consuming, and often generates a large amount of dust. For MDF, the deficient surface layer ranges from about 0.25 mm to about 1.3 mm thick. Conventionally, after the deficient surface layer is removed, the underlying more uniformly cured layer may be coated, laminated to, or glued to.

Various pre-press solutions have been applied in the manufacture of high-density fiberboards. High-density fiberboard manufacture, however, is typically not afflicted with the presence of a precure layer. Notably, the binders used in high-density fiberboard manufacture are slower curing, processed at higher temperatures and for longer periods of time than for medium density fiberboards. Consequently, the major surfaces of a high-density fiberboard are not typically sanded as with an MDF.

Several processes and chemistries have been attempted to eliminate the deficient surface layer of MDF with minimal success. As an example, alkaline materials have been added to wood fibers prior to blow-line blending. The fiberboards formed from wood fibers having alkaline material are said to have a glossy, hard surface that reduces the need for sanding. However, the need to produce economically, a medium density fiberboard without the deficient surface layer still exists.

### SUMMARY

Applicants have discovered a novel method of making a medium density fiberboard without the deficient surface layer. In one embodiment, this invention relates to a novel method of making a medium density fiberboard by applying a sealer composition to one or both surfaces of a fibermat of wood fibers prior to consolidation. The sealer composition preferably has at least one of a release agent, bonding agent, or plasticizer ingredient, and optionally one or more adjuvants. The method includes a press-and-cure cycle such that the unsanded medium density fiberboard product so produced preferably has a surface layer with a density that is substantially similar to or greater than the density of an underlying subsurface layer, and/or a cohesive strength that is substantially similar to or greater than the cohesive strength of an underlying subsurface layer.

Preferred medium density fiberboards of this invention have surface layers that accept paint, and/or can be laminated to or glued to without the need to remove a deficient surface layer, e.g., without a sanding step.

The present invention also relates to a medium density fiberboard that has an unsanded surface layer having a density and/or a cohesive strength that is substantially similar to or greater than the density and/or cohesive strength of the subsurface layer of the fiberboard.

### BRIEF DESCRIPTION OF THE DRAWINGS

FIG. 1 is a partial cross-sectional view of a fibermat prior to consolidation into a medium density fiberboard of the present invention.

FIG. 2 is a partial cross-sectional view of a medium density fiberboard of the present invention after consolidation.

These figures, which are idealized, are not to scale and are intended to be merely illustrative and non-limiting.

### Definitions

The term “MDF” denotes medium density fiberboard formed from wood fibers bonded together with the aid of one or more binders. In general, an MDF has a density ranging between about 400 and about 800 kgm/m³.

The term “deficient surface layer” relates to the outer layer of a conventional MDF that has undesirably low density and/or cohesive strength. The deficient surface layer is typically removed after the consolidation process (e.g. by sanding) so that the MDF may be used for its intended purpose.

The term “sanding” relates to the abrasive process by which the deficient surface layer in conventionally produced MDF is removed to make the final product usable for its intended purpose.

“Surface layer” means the 0.25 mm thick major surface layer of the medium density fiberboard (i.e., the outermost 0.25 mm thick layer of the MDF).

“Subsurface layer” is the layer from about 1.3 mm to about 2.6 mm below the surface of the MDF.

“Fibermat” is used in this document to denote the uncured and unconsolidated mat of fibers, one or more binders, and optionally wax.

“Consolidation” refers to the process of forming the fibermat into a fiberboard by compression and curing.

### DETAILED DESCRIPTION

The present invention provides a novel method of producing a medium density fiberboard (MDF) without a deficient surface layer. The present invention preferably provides an MDF with a surface layer that does not require removal, for example by sanding, prior to use. The unsanded surface layer of the MDF of the present invention can therefore be painted, laminated to and/or glued to as finished medium density fiberboards.

In one embodiment of the present invention, a sealer composition is preferably applied to at least one major surface of the fibermat prior to consolidation to produce an MDF that does not require the removal of the deficient surface layer. The application of the sealer composition may be accomplished by a variety of methods. These methods may include spraying, foam deposition, brushing, dipping, laminating a film, depositing a powder, coating, transferring from a belt or plate, and the like.

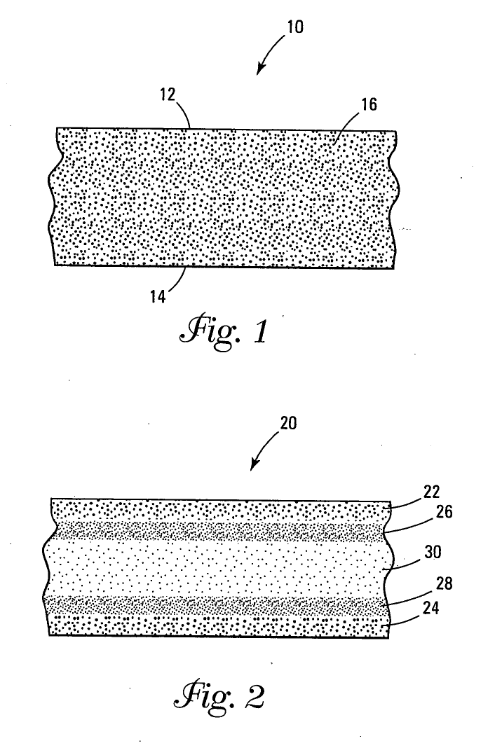

FIG. 1 illustrates an example of a partial cross-sectional view of the fibermat 10 prior to consolidation into an MDF of the present invention. The fibermat 10 comprises fibers (typically cellulosic, or other natural or synthetic fibers), binder and optionally wax. The fibermat 10 has two major opposing surfaces 12 and 14.

The cellulose wood fiber of the present invention is preferably prepared from tree logs that have been debarked. The tree logs may be used without debarking but debarked logs are preferred for optimization of the final product. Tree bark may introduce impurities of varying acidity. The cellulose wood fiber usable in this invention may be of any variety as is known in the art. For example, wood fibers from birch, chestnut, poplar, spruce, pine, fir, hemlock, beech, ash, kimba, gaboon, lindeen, eucaliptus, and the like, or combinations thereof may be usable. Other types of wood fiber, including wood chips from such materials as peeler cores, veneer residues, slabs, edgings or the like have been found acceptable. Wood waste, such as planar shavings and sawdust, and other cellulosic wood fiber prepared from recycled paper or cardboard may be used.

Preferably, the fibermat comprises one or more binders. Binders are typically blended into the wood fibers prior to consolidation. Binders may include resins, adhesives, and the like. The binders may provide the wood fibers collective integrity, thus allowing the wood fibers to maintain a structure or form that is sufficient to allow for the consolidation process into an MDF. Suitable binders usable include, for example, melamine, melamine urea-formaldehyde, urea-formaldehyde, phenolic, isocyanate or acrylic.

Optionally, wax is incorporated in the cellulose wood fibermat 10 of the present invention. The optional wax is preferably incorporated to provide water resistance to the fibermat 10. Suitable wax formulations include paraffin and petrolatum.

The fibermat 10 of the present invention is preferably accumulated on a belt in a size and quantity prior to consolidation such that the resultant MDF is at least as thick as the desired MDF product thickness. In a typical process, the thickness of the fibermat 10 may be up to about 20 times the final MDF thickness. The accumulation of the fibermat 10 prior to consolidation may be accomplished by varying methods, including, for example, layering of premixed fibermat. Layering of the fibermat 10 may also be used to control the texture of the fibermat 10, such as by fibermat particle size or any other desired texture. In a typical process, the particle size of the fibermat is preferably arranged such that the outer layers of the fibermat 10 comprise primarily particles of finer size than the middle layer of the fibermat 10.

The fibermat 10 may be accumulated on one or more belts prior to consolidation. The rotation of the belts thus serves to advance the fibermat as required prior to and during consolidation. It has been found that the fibermat on these belts tend to wrap around the belt as the fibermat is being advanced. The application of the sealer composition prior to consolidation may eliminate the tendency of the fibermat to wrap around the belt(s) during the advancement.

The consolidation of the fibermat 10 into an MDF typically includes the use of heat and pressure rollers or platens. For a typical pressing process, the effective pressure is preferably below about 3.5 MPa at temperatures of between about 140° C. and about 250° C. The combination of pressure and temperature determines the duration of press and heat cycle to obtain the MDF of the present invention. The effective press time is generally about 20 seconds per millimeter of board thickness, meaning that a board of 12 millimeters may require about 4 minutes per effective press cycle. It is understood that a fiberboard may be produced in a stack press or in a continuous cycle process. The effective press cycle refers to the time beginning from introduction of pressure to the fibermat 10 to the finished product thickness.

FIG. 2 illustrates a partial cross-sectional view of the MDF 20 of the present invention after consolidation. The MDF 20 comprises surface layers 22 and 24, subsurface layers 26 and 28, and a center region of the fiberboard 30. The present invention provides an MDF with a surface layer (measured from 0 to 0.25 mm) and a subsurface layer (measured from 1.3 to 2.6 mm) that have similar densities and/or cohesive strengths. There is a remarkable absence of a deficient surface layer as is conventionally the case with typical MDF manufacture.

In the conventional process, the deficient surface layer has either low density or low cohesive strength or both. Testing to show the presence or absence of a deficient surface layer may be accomplished, for example, using a tape such as Scotch™ 250 available from Minnesota Mining and Manufacturing Company (3M) of Saint Paul, Minn. The tape is applied and removed by a snap-off action. MDF products made according to conventional processes often have a deficient surface layer of about 0.25 mm up to about 1.3 mm in thickness that may be may be removed during this test. Underneath the deficient surface layer is the subsurface layer having a sufficiently formed MDF. MDF made according to the present invention is typically not presented with a deficient layer.

In contrast, the surface layer 22 of the present invention is substantially similar to or better than the subsurface layer 26. By substantially similar or better than is meant that the density and/or cohesive strength of the surface layer is similar to or greater than the density and/or cohesive strength of the subsurface layer.

As shown in Table 3 below, the deficient surface layer of a comparative MDF has lower density and cohesive strength than that of the subsurface layer. The deficient surface layer of the comparative example is deemed too weak to be acceptable as an MDF. These values are contrasted with the MDF prepared according to the process of the present invention. The surface and subsurface layers of the MDF of the present invention has substantially similar density and cohesive strength.

As discussed above, the MDF product of the present invention is preferably usable without the need to remove a deficient surface layer. The elimination of the need to remove a deficient surface layer offers several of the benefits as discussed above. The center region 30 of the MDF of the present invention may have yet a different average density when compared to the subsurface and surface layers. Although there may be discernable differences in average densities between these layers, the overall average density of the MDF of the present invention is typical of an MDF (i.e., within the range of about 400 to about 800 kg/m³).

The sealer composition of the present invention preferably comprises at least one of a release agent, bonding agent, or plasticizer ingredient. The sealer composition may also comprise an optional carrier. The sealer composition of the present invention may be applied to the fibermat as a premix in the layering process (accumulating the fibermat prior to consolidation). Thus, the premix preferably, may comprise a fine particle size (or preselected particle size) of fibermat and the sealer composition. The fibermat accumulation process may be arranged and controlled such that layer of premix of fibermat and sealer composition is applied to one or more of the major surfaces of the fibermat.

Preferred release agents of the present invention provide the consolidated surface of the MDF with properties such that the fiberboard does not stick to the plates or belt. In one embodiment, a suitable release agent for use in the present invention preferably comprises chemical compounds with both polar and oily ends, and other known chemicals that may serve such intended function. Without being bound to theory, the polar end is believed to have a higher affinity for the metal of the press while the oily end offers release from the metal.

Suitable release agents usable in the present invention include fatty acids; oils (e.g. linseed or other vegetable oils preferably emulsified in an aqueous media); epoxidized oils; waxes; acetylene diols; silicones and silanes; surfactants including sulfosuccinates, ethoxylated non-ionic surfactants, etc.; modified lignans; triglycerides; polyethylene and other olefin polymers; phosphate esters; pigments; ethylene and/or propylene oxides; sulfonates; polybutadienes, or combinations thereof. Presently preferred release agents are fatty acids and phosphate esters.

Suitable release agents include phosphate ester obtainable from Chem Ex of Piedmont, S.C. and Polyethylene emulsion obtainable as PM 1207 from Hopton Technologies, Inc. of Rome, Ga.

The release agents of the present invention are preferably present in an amount sufficient to cause the smooth release of the belt or platen from the consolidated fiberboard. Suitably, the release agent of the present invention is present in an amount up to about 80 weight percent of the sealer composition. Preferably, the release agent is present in an amount that ranges from about 1 to 80 weight percent, more preferably from about 5 to 50 weight percent, most preferably from about 10 to 25 weight percent of the sealer composition.

The sealer composition of the present invention may optionally include a bonding agent. The optional bonding agent useful in the present invention may be applied to the fibermat and to give it additional structural integrity. Structural integrity as referred to in the present invention includes, but is not limited to improved hardness, improved cohesive strength, improved smoothness and improved surface fiber adhesion of the MDF. In addition, some bonding agents may also function as a release agent.

Suitable optional bonding agents usable in the present invention include the aforementioned binders as well as other bonding agents such as polyvinyl alcohol, hydroxyethylcellulose, carboxymethylcellulose, casein, starch, polyvinyl acetate, vinyl chloride, acrylonitrile, styrene butadiene rubber (SBR), and the like.

Typical optional bonding agents useable in the present invention are preferably present in an amount sufficient to provide intended structural integrity. The amount of bonding agent usable in the present invention is suitably up to about 40 percent of the sealer composition. Preferably, the optional bonding agent is present in an amount ranging between about 1 and 40 weight percent of the sealer composition, more preferably between about 10 and 40 weight percent, and most preferably between about 20 and 30 weight percent.

The sealer composition of the present invention may optionally include a plasticizer. In some embodiments, the plasticizer may provide the sealer composition with improved “fiber-flow” and/or consolidation properties. While not intending to be bound by theory, the improved fiber flow properties are believed to facilitate the consolidation of the fibers in the fibermat to yield a higher density and/or more cohesive surface layer. It is also believed that the improved fiber-flow properties make for a more thermoplastic fibermat that is easily melded together by the consolidation process.

Suitable plasticizers for use in the present invention include, for example, oils such as those listed above under release agents; non reactive ureas; aminoplasts; glycols, including polyethylene and polypropylene glycols; water; low and medium molecular weight polymers such as acrylics, alkyds and cellulose derivatives. Preferred plasticizers include non-reactive ureas, glycols and aminoplasts.

Suitable plasticizers usable in the present invention may be present in an amount up to about 40 weight percent of the sealer composition. Preferably, the amount of plasticizer present in the present invention ranges between about 1 and 40 weight percent, more preferably between about 5 and 30 weight percent, and most preferably between about 10 and 30 weight percent of the sealer composition.

It has been discovered that certain release agents, plasticizers, and bonding agents can perform multiple functions. For example, certain release agents of the present invention may also function as a plasticizer and/or a bonding agent. Similarly, certain plasticizers may function as a release agent and/or a bonding agent, and certain bonding agents may function as a plasticizer and/or a release agent.

A carrier may optionally be employed in the sealer composition of the present invention. The carrier preferably acts as a vehicle and facilitates the incorporation of the sealer composition into the fibermat. Carriers are particularly useful in embodiments where the sealer composition is desired to be liquid. The carrier may also aid in heat transfer from the metal plates to the fibermat, as well as aid in the formation of a smooth MDF surface. Preferred carriers include non-VOC (volatile organic compound) solvents, non-hazardous solutions, and/or non-flammable solutions. Non-ground based ozone forming solvents may also be useful as carriers. Carriers usable in the present invention include, for example, water, alcohols, solvent blends, and the like. A presently preferred carrier is water.

As stated above, the MDF of the present invention may be produced by consolidation of a fibermat of wood fibers. The fibermat (e.g., wood fiber, optional binder, and optional wax) is typically blended and applied to a belt or base plate for consolidation.

As indicated above, the sealer composition of the present invention is preferably applied to the fibermat prior to consolidation with a sufficient amount of dwell time so that it can penetrate to the desired level of the fibermat. Depending on fibermat material, sealer composition, and consolidation process, the dwell time may range from 15 seconds to several hours prior to consolidation. Preferred dwell time is less than about 10 minutes, most preferably 2 to 6 minutes. The sealer composition may be applied to one or both surfaces of the fibermat. As indicated above, the application of the sealer composition may be accomplished by a variety of methods, including spraying, foam deposition, brushing on, dipping, film transfer, powder spraying, coating, transfer from a belt or plate, and the like. Spraying application is preferably preferred.

When required, or to facilitate a continuous process, the sealer composition of the present invention may be applied to either the belt (or plate) or the major surface that comes in contact with the belt (or plate). In addition of the aforementioned benefits related to the finished fiberboard, the sealer may also reduce static build-up, eliminate or reduce instances of the fibermat wrapping around the belts, (i.e., adhering to the belt and wrapping around to the underside of the loop as opposed to being transitioned to an adjacent belt or station in the process.

Consolidation of the fibermat typically includes pressing and curing processes. The fibermat is typically subjected to a pressure of up to about 3.5 MPa for up to about 5 minutes at about 175° C. Temperatures of about 140 to 250° C. may be used, depending on the texture or quality of the product desired, or other factors as is known in the art.

Surprisingly, the surface layer of the consolidated medium density fiberboard of the present invention has physical properties that are suitable for coating, laminating to and gluing to. Consequently, the present invention, in preferred embodiments, provides a finished MDF product that may be used without the need to remove a deficient surface layer, as is typically the case with conventional processes. Thus, several advantages are achievable due to the process of the present invention. These advantages include but are not limited to: (a) reduction in environmental pollution by elimination of the sanding process; (b) sanding belt cost reduction; and (c) time savings—elimination of removal of the deficient surface layer saves time.

For some applications, the MDF of the present invention may be resized, or otherwise refinished. Such processes may be incorporated to obtain a desired finish, smoothness, thickness, or a combination of these qualities. These added features are obtainable notwithstanding the ability to use the MDF of the present invention without removing the surface layer.

In an embodiment of the present invention, the MDF may preferably be formed into a molded or die-formed panel. For example, an MDF may be manufactured with a design profile or a desired molded configuration. The difficulty of sanding a profiled or molded MDF is eliminated.

### EXAMPLES

The following examples are offered to aid in understanding of the present invention and are not to be construed as limiting the scope thereof. Unless otherwise indicated, all parts and percentages are by weight.

### Test Methods

Tape Snap Test

This test evaluates the adhesion of the surface layer of the MDF after consolidation. The adhesive tape used was Scotch™ 250 tape available from Minnesota Mining and Manufacturing Company (3M Co.) of Saint Paul, Minn. A 6″ strip of the tape was used, with 2″ of the tape applied to the surface of the MDF and pressed to a uniform adhesion by finger. The tape was then pulled off in a snap-back action.

The amount of surface layer transferred from the MDF to the adhesive tape indicates the presence of a deficient layer. A rating scale of 0-10 was used, wherein “0” indicates no transfer to the tape, while “10” indicates severe transfer. A transfer rating of 0-3 is considered good for intended purposes; 4-7 is considered fair; and 8-10 indicates poor for intended purposes.

Density

Density maybe calculated by taking a square sample of board (0.305 m×0.305 m) and weighing it in grams. Then volume of the board (length×width×thickness) and the weight/volume ratio (density) may be calculated. For measuring the density profile of a MDF board, an x-ray-based, density-profiler system from Quintek Measuring Systems, Inc., Knoxville, Tenn. may be used. This system uses a computer running the Windows operating system, as well as a Data Translation (Marlboro, Mass.) PCI bus data-acquisition board to acquire the data. A 50-kV x-ray tube provides the source radiation, while the x-ray sensors generate a 1 to 10 V signal. Using this type of apparatus and when calibrated using a known density board, the density profile of an MDF board may be measured as a function of distance from the surface.

Cohesive Strength

Cohesive strength may be assessed using the tape snap test, comparing the “tape pull” versus a standard control. “Tape pull” evaluates the resistance to peel as well as the amount of fibers attached to the tape. A rating scale has been developed as follows:
Poor (0-3)=easy fiber lift which is similar to an unsealed MDF control.
Fair (4-7)=a tape pull somewhat improved compared to an unsealed MDF control.
Good (8-9)=a tape pull significantly better (i.e., stronger peel force or fewer fibers adhered to peeled tape or both) than an unsealed MDF control.
Excellent (10)=a tape pull substantially and significantly superior to the control in terms of force required to remove the tape and the amount of fiber remaining on the tape which is less than 1% of fiber removal.
   Scrape Adhesion Test

This test evaluates the resistance of the surface layer of the MDF to scraping. The test was accomplished using a Balanced Beam, Scrape Adhesion tester that was secured to a platform for supporting weights, and a rod at an angle of 45°. The rod was set so that the scraping loop contacts the surface directly below the weights. The scraping loop was a 1.6 mm diameter rod, bent into a “U” shape with an outside radius of 3.25, mm, and hardened to Rockwell Hardness of 56. The finish on the rod loop was smooth. The samples tested were 100×200 mn in dimension.

Failure is shown when the surface of the MDF is scraped, and the weight required to scrape was recorded in increments of 0.5 kg. An average of 5 measurements is used.

### Example 1

The following examples are illustrative of the preparation of the sealer compositions used to evaluate the present invention.

### Example 1, Run 1

### Preparation of Sealer Composition

Urea (CH 8027, obtainable from Ashland Specialty Chemical) was charged into a kettle containing hot water and slowly mixed with a Cowles blade mixer for about 40 minutes. Latex (HA16, obtainable from Rohm & Haas) was added and blended until all dissolved. A premixed blend of Deionized water, Surfactant (Triton X-100, obtainable from Dow Chemical) was added to the kettle and mixed for another 15 minutes at low speed. A charge of Phosphate Ester (obtainable from Chem Ex of Piedmont, S.C.) was then added and mixed. The composition was then strained through a 150-Micron filter bags into lined containers.

### Example 1, Run 2

### Preparation of Sealer Composition

Urea was charged into a kettle containing hot water at 95° C. and slowly mixed with a Cowles blade mixer until clear and seed free. Polyethylene Emulsion was added and blended until all dissolved.

A premixed blend of water at 50° C., Defoamer (BF 1008, obtainable from Nalco Chemical), Surfactant, Silicone Emulsion (DC290, obtainable from Dow Chemical), Linseed Oil (obtainable from Reichold, Inc.) were added to the kettle and mixed at high speed for another 10 minutes at low speed or until a uniform emulsion was achieved. The composition was then strained through a 150-Micron filter bags into lined containers.

### Example 1, Run 3

### Preparation of Sealer Composition

Hot water was charged to a Cowles tank and Fine Clay (Bentone EW, obtainable from NL Chemicals, Inc., Hightstown, N.J.) was sifted into a tank. The contents were mixed at high speed using a Cowles blade mixer for about 20 minutes, or until solution becomes seed free. Surfactant, Defoamer and Urea were added and blended until all dissolved and solution becomes seed free. Clay (obtainable from RT Vanderbilt Co., Norwalk, Conn.) was charged and mixed at high speed until all the pigment was dispersed to a 4+ grind on a Hegman gauge-North scale. Tall Oil Fatty Acid (TOFA, obtainable from NL Chemicals, Inc., Hightstown, N.J.), Amine, and Melamine Resin (obtainable from Bordon-Astro Industries, Morgantown, N.C.) were then added under mild agitation.

### Example 1, Run 4

### Preparation of Sealer Composition

Hot water was charged to a Cowles tank and Fine Clay (Bentone EW) was sifted into the tank. The contents were mixed at high speed using a Cowles blade mixer for about 20 minutes, or until solution becomes seed free. Dispersant (Tamol 165A, obtainable from Rolun & Haas), Defoamer, and Urea were added and blended until all dissolved and solution becomes seed free. Talc pigment (Nytal 300, obtainable from RT Vanderbilt Co., Norwalk, Conn.) was charged and mixed at high speed until all the pigment was dispersed to a 4+ grind on a Hegman gauge-North scale. The mixing speed was then slowed and water at ambient temperature was added. Polyethylene Emulsion and melamine resin were then added under mild agitation.

TABLE 1-b

| | Parts (kg) | | | |
|---|---|---|---|---|
| Ingredients | Run 1 | Run 2 | Run 3 | Run 4 |
| Water | 230 | 300 | 276 | 218 |
| Fine Clay | | | 1 | 1.7 |
| Surfactant | 9 | | 1 | |
| Dispersant | | | | 1.7 |
| Defoamer | | | 0.3 | 0.5 |
| Urea | 80 | 200 | 10 | 17 |
| Clay | | | 88 | |
| Talc | | | | 142 |
| PE Emulsion | | 20 | | 17 |
| Silicone Emulsion | | 20 | | |
| TOFA | | | 10 | |
| Amine | | | 2.8 | |
| Melamine Resin | | | 55.3 | 91 |
| Phosphate Ester | 50 | | | |
| Linseed Oil | | 5 | | |
| Latex | 10 | | | |

### Example 3

### Preparation of MDF

6×8 inch (0.152×0.203 m) fibermats were prepared by spray applying 20 wet grams/ft² (20 wet grams/0.093 m²) using the sealer compositions of Example 1. Consolidation was accomplished by pressing to stops, at 205° C. for 8 minutes between stainless steel smooth caul plates. The consolidated fiberboards were evaluated for density, cohesive strength, Tape Snap as shown in Table 3 below. A comparative fiberboard, without application of a sealer composition as is conventionally prepared, was similarly evaluated and is included as Run A.

TABLE 3
Evaluation of MDF

| | Scrape | Cohesive | Density | |
|---|---|---|---|---|
| Ex.1/Run # | Adhesion (kg) | Strength | (kg/m) | Tape Snap |
| 1 | 10 | 9 | 737 | 5 |
| 2 | 10 | 10 | 737 | 1 |
| 3 | 7 | 7 | 737 | 5 |
| 4 | 8 | 7 | 737 | 5 |
| A (Comparative) | 0.5 | 0 | 737 | 10 |

### Example 4

### Evaluation of Varying Amounts of Sealer Composition

In these examples, the concentrations of sealer composition were varied as shown below. The various concentrations were then applied to the fibermat and consolidated into fiberboards. The fiberboards were then evaluated for cohesive strength, density and tape snap.

TABLE 4
Various Amounts of Sealer Composition of Ex. 1, Run 1

| | Scrape Adhesion | | Density | |
|---|---|---|---|---|
| Amount | (kg) | Cohesive Strength | (kg/m³) | Tape Snap |
| 0.2 | 6 | 4 | 737 | 10 |
| 0.4 | 10 | 7 | 737 | 8 |
| 0.6 | 10 | 9 | 737 | 3 |
| 0.8 | 10 | 10 | 737 | 0 |

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

1. A method of making fiberboard having a density ranging between about 400 and about 800 kg/m³, comprising:
providing a fibermat having one or more layers of a mixture of wood fibers and a binder comprising melamine, melamine urea-formaldehyde, urea-formaldehyde, isocyanate, acrylic or combination thereof;
providing a sealer composition comprising a) glycol, urea or aminoplast and b) release agent;
applying the sealer composition to at least one major surface of the fibermat;
allowing the sealer composition to penetrate into the fibermat for a dwell time sufficient to form fiberboard with an unsanded surface layer having a cohesive strength that is substantially similar to or greater than the cohesive strength of the underlying subsurface layer; and
consolidating the fibermat.

2. The method of claim 1, wherein the binder comprises melamine, melamine urea-formaldehyde, or combination thereof.

3. The method of claim 1, wherein the fibermat further comprises wax.

4. The method of claim 1, wherein the fibermat comprises two or more layers having different particle sizes.

5. The method of claim 1, wherein the sealer composition is applied by spraying, foam deposition, coating, brushing, transferring from a belt, transferring from a plate, dipping, depositing a powder, or laminating a film.

6. (canceled)

7. The method of claim 1, wherein the release agent comprises one or more fatty acids, oils, epoxidized oils, waxes, acetylene diols, silicones, silanes, surfactants, modified lignans, triglycerides, polyethylene, olefin polymers, phosphate esters, pigments, ethylene oxides, propylene oxides, sulfonates, polybutadienes, or combination thereof.

8. The method of claim 1, wherein the release agent includes a fatty acid.

9. The method of claim 1, wherein the release agent includes a phosphate ester.

10. The method of claim 1, wherein the sealer composition comprises between about 1 and 80 weight percent release agent.

11. The method of claim 1, wherein the sealer composition comprises between about 10 and 25 weight percent release agent.

12. The method of claim 1, wherein the sealer composition further comprises bonding agent comprising polyvinyl alcohol, hydroxyethylcellulose, carboxymethylcellulose, casein, starch, polyvinyl acetate, vinyl chloride, acrylonitrile, styrene butadiene rubber or combination thereof.

13-14. (canceled)

15. The method of claim 12, wherein the sealer composition comprises between about 20 and 30 weight percent bonding agent.

16. The method of claim 1, wherein the sealer composition further comprises plasticizer.

17. The method of claim 16, wherein the plasticizer comprises one or more acrylics, alkyds, cellulose derivatives, or combination thereof.

18. The method of claim 1, wherein the sealer composition comprises a glycol.

19. The method of claim 1, wherein the sealer composition comprises non-reactive urea.

20. The method of claim 16, wherein the sealer composition comprises between about 1 percent and 40 weight percent plasticizer.

21. The method of claim 16, wherein the sealer composition comprises between about 10 percent and 30 weight percent plasticizer.

22. The method of claim 1, wherein the sealer composition further comprises a carrier.

23. The method of claim 22, wherein the carrier comprises water.

24. A medium density fiberboard formed according to claim 1.

25. A medium density fiberboard having an unsanded surface layer with a density that is substantially similar to the density of the subsurface layer of the fiberboard.

26-31. (canceled)

32. A method according to claim 1, wherein the sealer composition is applied to two major surfaces of the fibermat.

33. A method according to claim 1, wherein the fibermat does not have a deficient surface layer.

34. A method according to claim 1, wherein there is no transfer of the unsanded surface layer to adhesive tape using a tape snap test.

35. A method according to claim 1, wherein the unsanded surface layer substantially accepts paint, lamination or gluing, without being sanded.

36. A method according to claim 1, wherein the unsanded surface layer density is substantially similar to or greater than the subsurface layer density.

37. A method according to claim 1, wherein the fiberboard has a center region having a different average density than the subsurface and surface layers.

38. A method according to claim 1, wherein the dwell time is 15 seconds to several hours prior to consolidation.

39. A method according to claim 1, wherein the dwell time less than about 10 minutes.

40. A method according to claim 1, wherein the dwell time is 2 to 6 minutes prior to consolidation.
